(19) United States
(12) Patent Application Publication
(10) Pub. No.: US 2014/0176430 A1
(43) Pub. Date: Jun. 26, 2014

(54) INTELLIGENT SWITCHING SYSTEM, ELECTRONIC DEVICE THEREOF, AND METHOD THEREOF

(71) Applicants: HON HAI PRECISION INDUSTRY CO., LTD., New Taipei (TW); HONG FU JIN PRECISION INDUSTRY(ShenZhen) CO., LTD., Shenzhen (CN)

(72) Inventor: XIN GUO, Shenzhen (CN)

(73) Assignees: HON HAI PRECISION INDUSTRY CO., LTD., New Taipei (TW); HONG FU JIN PRECISION INDUSTRY(ShenZhen) CO., LTD., Shenzhen (CN)

(21) Appl. No.: 14/140,567

(22) Filed: Dec. 26, 2013

(30) Foreign Application Priority Data
Dec. 26, 2012 (CN) 2012105738126

(51) Int. Cl. G09G 5/12; G06F 3/01

(52) U.S. Cl. CPC G09G 5/12; G06F 3/013
USPC 345/156

(57) ABSTRACT

A method for intelligent switching is applied to an electronic device. The electronic device includes a camera, a storage unit, a processor, and a wireless communication unit. The camera captures a picture when each time a predetermined time interval elapses. The storage unit stores a predetermined viewing range of values of viewing angles of the eyes of a user relating to the user viewing a display screen of the electronic device. The method includes, first, constructing a picture according to the input signals. Second, a connection signal is generated when the constructed picture is determined to contain a facial image of the user and the viewing angle of eyes of the user in the facial image falls within the predetermined range of values. Lastly, a connection is established between the electronic device and the wireless device. An electronic device and a system for intelligent switching are also provided.

### BACKGROUND

1. Technical Field

The present disclosure relates to intelligent switching systems and intelligent switching methods, and especially to an intelligent switching system and an intelligent switching method utilizing detection of a facial image of a user.

2. Description of Related Art

A wireless mouse can be coupled to a computer or a number of computers, but the wireless mouse can only control one computer at a time. When the wireless mouse is wirelessly connected with a given computer and is then required to control another computer, the wireless connection between the given computer and the wireless mouse should be cut off, and then a wireless connection between the other computer and the wireless mouse should be created. This is inconvenient and troublesome.

Therefore, what is needed is a method and a system for intelligent switching which can alleviate or even overcome the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts or sections throughout the drawings.

FIG. 1 is a schematic diagram of a group of devices that incorporate a system for intelligent switching in accordance with an embodiment of the present invention.

FIG. 2 is a block diagram of a wireless device of FIG. 1, in accordance with the embodiment of the present invention.

FIG. 3 is a block diagram of one electronic device of FIG. 1, in accordance with the embodiment of the present invention.

FIGS. 4 and 5 together constitute a flowchart of an intelligent switching method for an electronic device, such as the one of FIG. 3, in accordance with an embodiment of the present invention.

### DETAILED DESCRIPTION

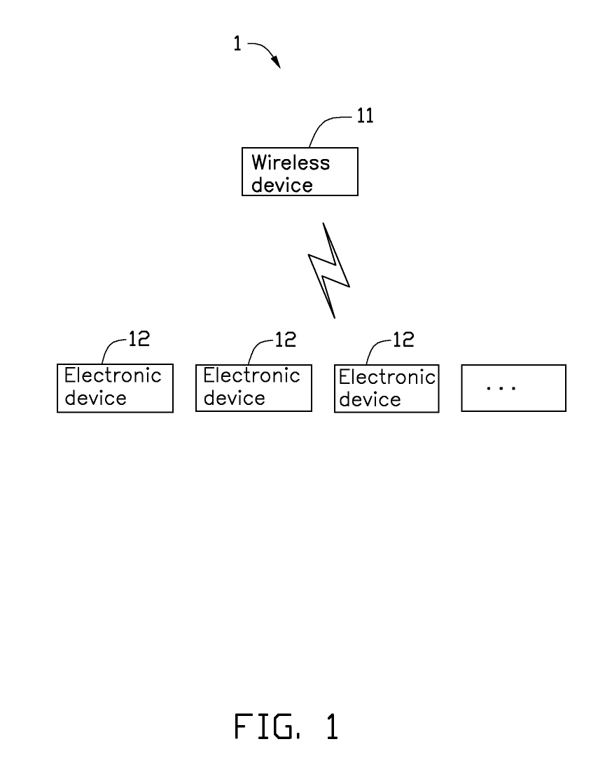

FIG. 1 is an embodiment of a system 1 for intelligent switching. The system 1 is employed by and resides in a wireless device 11 and a number of electronic devices 12. The wireless device 11 is a wireless keyboard or a wireless mouse, for example. In this embodiment, the wireless device 11 is a wireless mouse. The electronic device 12 is selected from a group consisting of a desktop computer, a personal computer (PC), or a tablet PC, for example. The wireless device 11 can wirelessly communicate with the electronic devices 12.

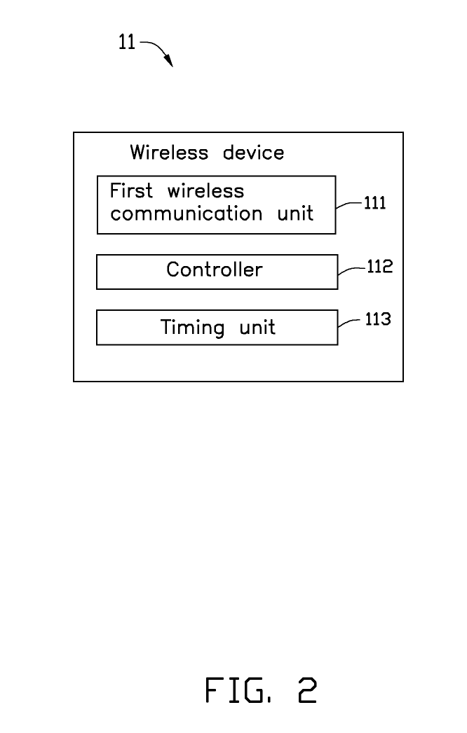

FIG. 2 shows a block diagram of the wireless device 11. The wireless device 11 includes a first wireless communication unit 111 and a controller 112.

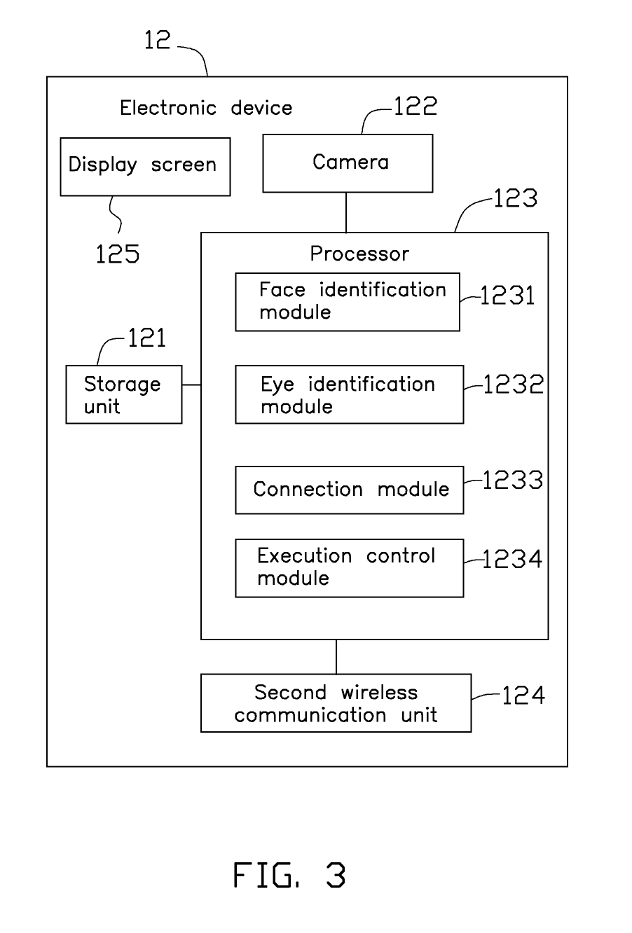

FIG. 3 shows a block diagram of one of the electronic devices 12. For the purposes of this description, all the electronic devices 12 can be considered to have the same structure. Each electronic device 12 includes a storage unit 121, a camera 122, a processor 123, and a second wireless communication unit 124.

The storage unit 121 stores a predetermined range of values of viewing angles of a user's eyes. The viewing angles relate to the user viewing a display screen 125 of the electronic device 12. For example, the viewing angles may be measured relative to a lengthwise span of the display screen 125 (e.g. Y-axis), and/or relative to a widthwise span of the display screen 125 (e.g. X-axis).

The camera 122 is configured for periodically capturing a picture and generating a corresponding picture signal. These functions are performed each time a predetermined time interval elapses.

The system 1 includes a plurality of face identification modules 1231 and a plurality of eye identification modules 1232. One of the face identification modules 1231 and one of the eye identification modules 1232 are employed by and reside in the processor 123 of a respective one of the electronic devices 12.

For each electronic device 12, the face identification module 1231 is configured for constructing a picture according to the picture signal generated by the camera 122, and determining whether the constructed picture includes a facial image. If the constructed picture includes a facial image, typically the facial image will be that of a user viewing the display screen 125 of the electronic device 12. The face identification module 1231 is further configured for obtaining the facial image from the captured picture when the captured picture includes a facial image.

The eye identification module 1232 is configured for identifying the viewing angle of the user's eyes in the obtained facial image, and determining whether the viewing angle of the user's eyes falls within the predetermined range of values of viewing angles. The eye identification module 1232 is further configured for generating a connection signal for establishing wireless connection when the viewing angle of the user's eyes in the obtained facial image falls within the predetermined range. That is, when the viewing angle of the user's eyes falls within the predetermined range of values of viewing angles, the user is facing the electronic device 12; and it is assumed that the user wishes to employ the wireless device 11 in order to operate the electronic device 12.

The second wireless communication unit 124 is configured for transmitting the connection signal in order to establish wireless connection to the wireless device 11.

The first wireless communication unit 111 of the wireless device 11 is configured for receiving the connection signal. The controller 112 of the wireless device 11 determines whether the wireless device 11 is currently connected to another one of the electronic devices 12. The controller 112 of the wireless device 11 also generates a feedback signal, and controls the first wireless communication unit 111 to transmit the generated feedback signal to the electronic device 12 which the user is viewing but which is not yet connected with the wireless device 11 (hereinafter, “the requesting electronic device 12”).

In the embodiment, when the controller 112 determines that the wireless device 11 is connected to another one of the electronic devices 12, the controller 112 disconnects the wireless device 11 from the other electronic device 12, generates the feedback signal, and controls the first wireless communication unit 111 to transmit the generated feedback signal to the requesting electronic device 12.

The second wireless communication unit 124 of the requesting electronic device 12 is configured for receiving the feedback signal.

In this embodiment, the system 1 further includes a plurality of connection modules 1233. One of the connection modules 1233 is employed by and resides in the processor 123 of a respective one of the electronic devices 12. When an electronic device 12 is the requesting electronic device 12, the connection module 1233 is configured for establishing connection between the wireless device 11 and the requesting electronic device 12.

The wireless device 11 generates input signals in response to applied input operations of a user if any given electronic device 12 is connected to the wireless device 11. The first wireless communication unit 111 transmits the input signals to the electronic device 12 which is currently connected with the wireless device 11.

The system 1 further includes a plurality of execution control modules 1234. One of the execution control modules 1234 is employed by and resides in the processor 123 of a respective one of the electronic devices 12. For each electronic device 12, the execution control module 1234 is configured for executing corresponding operations in response to the input signals received by the second wireless communication unit 124 of the electronic device 12.

In the present embodiment, if a given electronic device 12 is connected with the wireless device 11, the face identification module 1231 is configured for constructing a picture according to the picture signal generated by the camera 122 at the expiry of each predetermined time interval. In addition, the face identification module 1231 is configured for determining whether the constructed picture still contains a facial image. The connection module 1233 is configured for disconnecting the electronic device 12 from the wireless device 11 when it is determined that the constructed picture contains no facial image.

In one embodiment, when a given electronic device 12 is connected with the wireless device 11, the connection module 1233 is configured for determining whether the second wireless communication unit 124 of the electronic device 12 receives an input signal generated by the wireless device 11 within a predetermined time period. In addition, the connection module 1233 is configured for disconnecting the electronic device 12 from the wireless dev ice 11 when the second wireless communication unit 124 receives no input signal generated by the wireless device 11 within the predetermined time period.

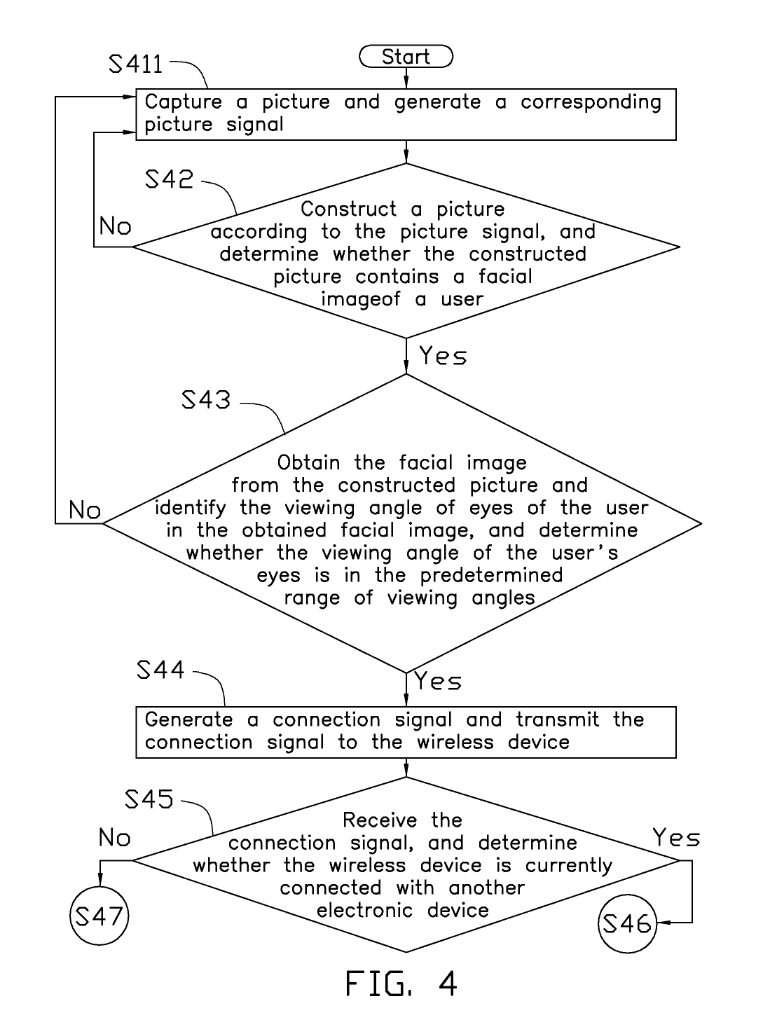

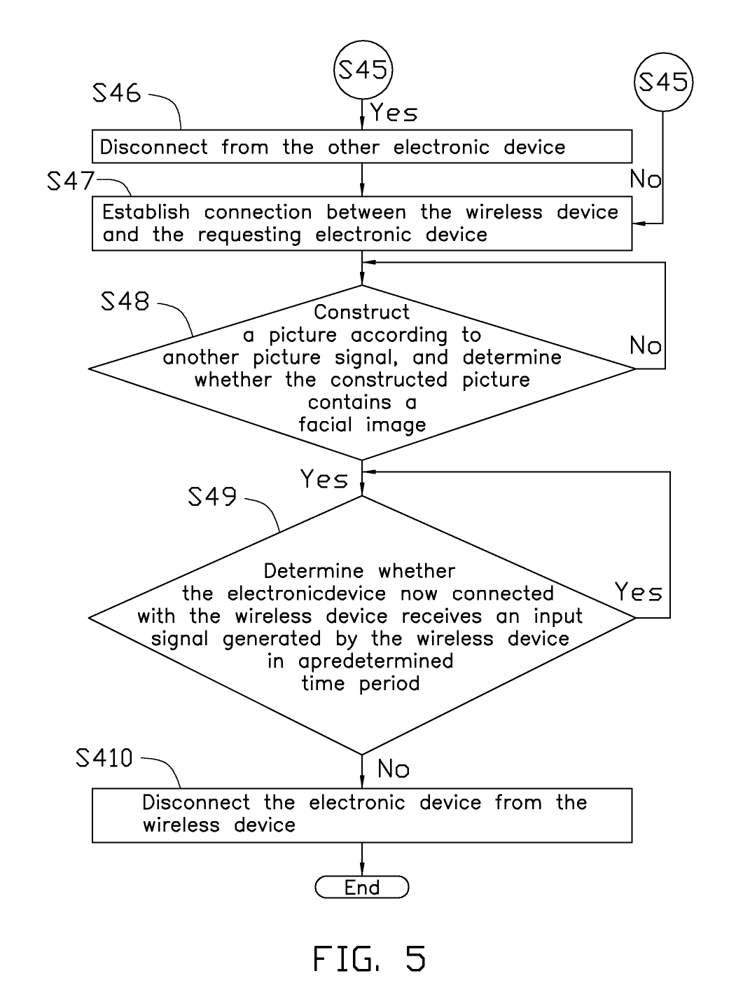

FIGS. 4 and 5 together constitute a flowchart of a method for intelligent switching for an electronic device such as any given electronic device 12. The electronic device 12 includes a storage unit 121 and a camera 122. The storage unit 121 stores a predetermined range of values of viewing angles of a user's eyes, relating to the user viewing a display screen 125 of the electronic device 12. The camera 122 is configured for capturing a picture each time a predetermined time interval elapses. The method typically includes the following steps, each of which relates to the various components contained in the electronic device 12.

In step S41, the camera 122 of the electronic device 12 captures a picture and generates a corresponding picture signal each time the predetermined time interval elapses.

In step S42, the face identification module 1231 of the electronic device 12 constructs a picture according to the picture signal, and determines whether the constructed picture includes a facial image. If the determination is yes, the process goes to step S43. If the determination is no, the process goes back to step S41.

In step S43, the face identification module 1231 of the electronic device 12 obtains the facial image from the constructed picture. The eye identification module 1232 identifies the viewing angle of the user's eyes in the obtained facial image, and determines whether the viewing angle of the user's eyes falls within the predetermined range of values of viewing angles. If the determination is yes, the process goes to step S44. If the determination is no, the process goes back to step S41.

In step S44, the eye identification module 1232 of the electronic device 12 generates a connection signal for establishing connection, and the second wireless communication unit 124 of the electronic device 12 transmits the connection signal to the wireless device 11.

In step S45, the first wireless communication unit 111 of the wireless device 11 receives the connection signal, and the controller 112 of the wireless device 11 determines whether the wireless device 11 is currently connected with another electronic device 12. If the determination is yes, the process goes to step S46. If the determination is no, the process goes to step S47.

In step S46, the controller 112 of the wireless device 11 disconnects the wireless device 11 from the electronic device 12 which is currently connected with the wireless device 11, and generates a feedback signal. The controller 112 of the wireless device 11 controls the first wireless communication unit 111 to transmit the feedback signal to the requesting electronic device 12 which is not yet connected to the wireless device 11.

In step S47, the second wireless communication unit 124 of the requesting electronic device 12 receives the feedback signal. In addition, the connection module 1233 of the requesting electronic device 12 establishes connection between the wireless device 11 and the requesting electronic device 12.

In step S48, the face identification module 1231 of the electronic device 12 now connected with the wireless device 11 constructs a picture according to another picture signal generated by the camera 122. In addition, the face identification module 1231 determines whether the constructed picture contains a facial image. If the determination is yes, the process goes to step S49. If the determination is no, the process goes back to the beginning of step S48.

In step S49, the connection module 1233 of the electronic device 12 currently connected with the wireless device 11 determines whether the second wireless communication unit 124 of the currently connected electronic device 12 receives an input signal generated by the wireless device 11 within a predetermined time period. If the determination is yes, the process goes back to the beginning of step S49. If the determination is no, the process goes to step S410.

In step S410, the connection module 1233 of the currently connected electronic device 12 disconnects the electronic device 12 from the wireless device 11.

Although the present disclosure has been specifically described on the basis of various embodiments thereof, the disclosure is not to be construed as being limited thereto. Various changes or modifications may be made to the embodiments without

What is claimed is:

1. A method for intelligent switching for an electronic device having a storage unit and a display screen, the storage unit having stored therein a predetermined range of values of viewing angles of the eyes of a user relating to the user viewing the display screen, the method comprising:
capturing a picture and generating a corresponding picture signal;
constructing a picture according to the picture signal;
determining whether the constructed picture contains a facial image of a user;
identifying a viewing angle of the eyes of the user in the facial image and determining whether the viewing angle of the eyes of the user falls within the predetermined range of values of viewing angles when the identified picture contains a facial image of a user; and
establishing a wireless connection between the electronic device and a wireless device when the viewing angle of the eyes of the user falls within the predetermined range of values of viewing angles.

2. The method as described in claim 1, wherein identifying a viewing angle of the eyes of the user in the facial image and determining whether the viewing angle of the eyes of the user falls within the predetermined range of values of viewing angles when the identified picture contains a facial image of a user comprises:
obtaining the facial image from the constructed picture when the constructed picture contains a facial image of the user;
identifying the viewing angle of the eyes of the user in the obtained facial image;
determining whether the identified viewing angle of the eyes of the user falls within the predetermined range of values of viewing angles; and
generating a connection signal for establishing connection when the identified viewing angle of the eyes of the user falls within the predetermined range of values of viewing angles.

3. The method as described in claim 2, further comprising:
transmitting the connection signal to the wireless device, and receiving a feedback signal from the wireless device; and
establishing a connection between the electronic device and the wireless device according to the feedback signal.

4. The method as described in claim 3, wherein after establishing connection between the electronic device and the wireless device when the identified viewing angle of the eyes of the user falls within the predetermined range of values of viewing angles, the method further comprises:
constructing a picture according to another picture signal;
determining whether the constructed picture contains a facial image of a user; and
disconnecting the electronic device from the wireless device when the constructed picture contains no facial image of a user.

5. The method as described in claim 3, wherein after establishing connection between the electronic device and the wireless device when the identified viewing angle of the eyes of the user falls within the predetermined range of values of viewing angles, the method further comprises:
determining whether the electronic device receives an input signal generated by the wireless device within a predetermined time period; and
disconnecting the electronic device from the wireless device when the electronic device does not receive an input signal generated by the wireless device within the predetermined time period.

6. The method as described in claim 1, wherein capturing a picture and generating a corresponding picture signal is performed each time a predetermined time interval elapses.

7. An electronic device, comprising:
a display screen;
a storage unit, configured for storing therein a predetermined range of values of viewing angles of the eyes of a user relating to the user viewing the display screen;
a camera, configured for capturing a picture and generating a corresponding picture signal;
a face identification module, configured for constructing a picture according to the picture signal, and determining whether the constructed picture contains a facial image of a user;
an eye identification module, configured for identifying a viewing angle of the eyes of the user in the facial image and determining whether the viewing angle of the eyes of the user falls within the predetermined range of values of viewing angles when the constructed picture contains a facial image of the user; and
a connection module, configured for establishing a wireless connection between the electronic device and a wireless device when the viewing angle of the eyes of the user falls within the predetermined range of values of viewing angles.

8. The electronic device as described in claim 7, wherein the eye identification module is further configured for obtaining the facial image from the constructed picture when the constructed picture contains a facial image of the user, and generating a connection signal for establishing connection when the viewing angle of the eyes of the user falls within the predetermined range of values of viewing angles.

9. The electronic device as described in claim 8, further comprising:
a wireless communication unit, configured for transmitting the connection signal to a wireless device, and receiving a feedback signal from the wireless device; wherein the connection module is configured for establishing the connection between the electronic device and the wireless device according to the feedback signal.

10. The electronic device as described in claim 9, wherein when the electronic device and the wireless device are connected, the face identification module is further configured for constructing a picture according to another picture signal, determining whether the constructed picture contains a facial image of the user, and disconnecting the electronic device from the wireless device when the constructed picture contains no facial image of the user.

11. The electronic device as described in claim 9, wherein when the electronic device and the wireless device are connected, the connection module is further configured for determining whether the electronic device receives an input signal generated by the wireless device within a predetermined time period, and disconnecting the electronic device from the wireless device when the electronic device receives no input signal generated by the wireless device within the predetermined time period.

12. The electronic device as described in claim 7, wherein the camera is configured for capturing a picture and generating a corresponding picture signal each time a predetermined time interval elapses.

13. A system for intelligent switching, which is applied to one wireless device and one or more electronic devices, each electronic device comprising a display screen and a storage unit having stored therein a predetermined range of values of viewing angles of the eyes of a user relating to the user viewing the display screen, and each electronic device further comprising a camera configured for capturing a picture and generating a corresponding picture signal, the system comprising:
a face identification module, configured for constructing a picture according to the picture signal, and determining whether the constructed picture contains a facial image of a user;
an eye identification module, configured for identifying a viewing angle of the eyes of the user in the facial image and determining whether the viewing angle of the eyes of the user falls within the predetermined range of values of viewing angles when the constructed picture contains a facial image of the user; and
a connection module, configured for establishing a wireless connection between a given one of the electronic devices and a wireless device when the viewing angle of the eyes of the user falls within the predetermined range of values of viewing angles.

14. The system as described in claim 13, wherein the eye identification module is further configured for obtaining the facial image from the constructed picture when the constructed picture contains a facial image of the user, identifying the viewing angle of the eyes of the user in the obtained facial image, determining whether the identified viewing angle of the eyes of the user falls within the predetermined range of values of viewing angles, and generating a connection signal for establishing connection when the identified viewing angle of the eyes of the user falls within the predetermined range of values of viewing angles.

15. The system as described in claim 14, further comprising the one or more electronic devices, wherein the given one of the electronic devices comprises a wireless communication unit configured for transmitting the connection signal to the wireless device, and receiving a feedback signal from the wireless device, and the connection module is configured for establishing the connection between the given one of the electronic devices and the wireless device according to the feedback signal.

16. The system as described in claim 13, wherein when the given one of the electronic devices and the wireless device are connected, the face identification module is further configured for constructing a picture according to another picture signal, determining whether the constructed picture contains a facial image of the user, and disconnecting the given one of the electronic devices from the wireless device when the constructed picture contains no facial image of the user.

17. The system as described in claim 13, wherein when the given one of the electronic devices and the wireless device are connected, the connection module is further configured for determining whether the given one of the electronic devices receives an input signal generated by the wireless device within a predetermined time period and disconnecting the given one of the electronic devices from the wireless device when the given one of the electronic devices receives no input signal generated by the wireless device within the predetermined time period.

18. The system as described in claim 13, further comprising the wireless device, wherein the wireless device comprises:
a wireless communication unit, configured for receiving the connection signal; and
a controller, configured for generating a feedback signal in response to the connection signal, and controlling the wireless communication unit to transmit the feedback signal to the given one of the electronic devices.

19. The system as described in claim 18, wherein the controller is configured for determining whether the wireless device is currently connected with another one of the electronic devices, and generating the feedback signal when the wireless device is not currently connected with another one of the electronic devices.

20. The system as described in claim 19, wherein the controller is further configured for, when the wireless device is connected with the another one of the electronic devices, disconnecting the wireless device from the another one of the electronic devices before generating the feedback signal.
